(19) United States
(12) Patent Application Publication
(10) Pub. No.: US 2021/0183287 A1
(43) Pub. Date: Jun. 17, 2021

(54) SOLID FREEFORM FABRICATION UTILIZING IN SITU INFUSION AND IMAGING

(71) Applicant: Trio Labs, Inc., Research Triangle Park, NC (US)

(72) Inventor: Adam T.C. Steege, Durham, NC (US)

(21) Appl. No.: 16/636,289

(22) PCT Filed: Aug. 2, 2018
(86) PCT No.: PCT/US2018/044938

§ 371 Date: Feb. 3, 2020

Related U.S. Application Data
(60) Provisional application No. 62/540,392, filed on Aug. 2, 2017.

(51) Int. Cl. G09G 3/00; H04N 5/341; G02B 27/30

(52) U.S. Cl. CPC G09G 3/007; G02B 27/30; H04N 5/341

(57) ABSTRACT

A fabrication device includes a platform to receive layers of build material for production of a 3-dimensional solid representation of a digital model, a component to deposit layers of build material, and an imaging component to bind respective portions of the build material into cross sections representative of portions of data contained in the digital model. The first imaging component may be a programmable planar light source utilizing specialized refractive pixel shifting mechanism, or other imaging system. The platform includes an infusion system for providing photocurable resin to the component being built. The object may be a powder composite component using any of a variety of powder materials or a plastic component.

### CROSS-REFERENCE TO RELATED APPLICATION

The present application claims the benefit of U.S. Provisional Patent Application Ser. No. 62/540,392, filed Aug. 2, 2017, the disclosure of which is incorporated herein by reference in its entirety.

### TECHNICAL FIELD

The subject matter disclosed herein relates generally to solid freeform fabrication of objects. More particularly, the subject matter disclosed herein relates to systems, devices, and methods for solid freeform fabrication of objects from metal, plastic, ceramic, and composite materials comprising combinations of one or more types of material.

### BACKGROUND

Embodiments described herein generally relate to devices and methods for the solid freeform fabrication of objects from metal, plastic, ceramic, and composite materials comprising combinations of one or more types of material.

Additive manufacturing (AM), also known as solid freeform fabrication (SFF), 3D printing (3DP), direct digital manufacturing (DDM), and solid imaging, has increasingly become a widely adopted method of prototyping both visually demonstrative and functional parts. In some instances, this has become a cost-effective means for production manufacturing as well. A wide variety of means for producing components based on digital models exist, and all have reduced the time and cost required for a complete design cycle, which has improved the pace of innovation in many industries.

Generally, SFF is accomplished in a layerwise fashion, where a digital model is split into horizontal slices, and each slice is produced as a 2D image on a build surface. The sequential fabrication of these slices produces an aggregate collection of thin layers which collectively compose the 3-dimensional object represented by the digital model. In contrast to traditional fabrication techniques, such as Computer Numerically Controlled (CNC) machining, injection molding, and other means, SFF has markedly reduced production time and cost, and as such has been widely adopted for research and development purposes where low volume production with traditional means would be exceedingly expensive. Additionally, SFF devices generally require less expertise to operate when compared to CNC machines. The cost of individual parts produced from CNC machines is generally higher, owing to longer setup times and higher costs of machine operation. CNC-produced parts will often have stronger and more detailed features than SFF-produced parts, which may make them desirable for some applications. Until SFF techniques can produce parts with the resolution and functionality of CNC-produced parts, the usage of SFF in part production will remain constrained.

Powder Injection Molding (PIM) is a mass production technique which has been widely adopted as a means of producing high precision components in materials which would not traditionally be possible with other molding methods. A powder is blended with a resin binder to form an injection feedstock, which is injected into a mold, similar to plastic injection molding. The part produced is a powder composite part, called a “green” part. The green part is subjected to a process called debinding, in which most of the binder is removed. The resulting part is called a “brown” part. This brown part is then subjected to thermal treatment to cause the powder particles to sinter together. The part shrinks during this process, and voids between the powder particles are removed. The final result is a part with near full density. Further post-processing may be utilized to achieve over 99.5% density.

Some of the most common techniques for SFF include stereolithography (SLA), selective deposition modeling (SDM), fused deposition modeling (FDM), and selective laser sintering (SLS). These approaches vary in the type of materials they can use, the manner in which layers are created, and the subsequent resolution and quality of parts produced. Typically, layers are produced in a bulk material deposition method, or in a selective material deposition method. In techniques that employ a bulk deposition method for layer production, layer imaging is typically accomplished by a thermal, chemical, or an optical process. There is one technology, binder jetting, which utilizes inkjet print heads to deposit binder into a powder bed to produce a part similar to the previously described green part in a PIM process. This green part can be post-processed in the same manner to produce a final component. Unfortunately, due to imperfections in the process of producing the green part, the final components produced through this process often fail to meet tolerances for high precision applications. Additionally, the precision and speed of the binder jetting process is limited.

### SUMMARY OF THE INVENTION

Embodiments of a device for solid freeform fabrication and associated methods are herein disclosed for the production of components (e.g., plastic, metal, and ceramic parts) for a variety of applications.

In some embodiments, the SFF methods and devices disclosed herein may include a surface for receiving layers of material for production of a 3-dimensional solid representation of a digital model, a component or components for depositing the required layers of build material, and a component or components for imaging the build material into cross sections representative of data contained in a digital model. In one embodiment, the build material is composed of a particulate material (e.g., powder) and a photocurable resin material. A powder transfer device is configured to deliver a powder material to a build platform, a photocurable material supply system is in communication with the build platform and is configured to deliver at least one photocurable material into at least a portion of the deposited powder material, and an imaging device is configured to selectively irradiate the photocurable material to at least partially solidify a layer of a powder composite component. The combination of particulate materials and photocurable resin materials at the build surface overcomes the rheological constraints of aforementioned devices which have been used to produce powder composite parts.

In addition, in some embodiments, the methods and devices described below may utilize particulate material (e.g., ceramic, plastic, or metal) as one of the build materials. Parts produced from this device may be treated after the build process is complete to facilitate bonding between adjacent particles. Such treatment includes but is not limited to thermal, chemical, and pressure treatment, and combinations of these. The results of this fabrication and treatment process include but are not limited to solid metal parts, solid ceramic parts, solid plastic parts, porous metal parts, porous ceramic parts, porous plastic parts, solid composite plastic parts, and composite parts comprising one or more types of material.

Material deposition of particulate material may be achieved through several means, including but not limited to spreading via a blade mechanism, spreading via a combination of a powder metering system and blade mechanism, spreading via a combination of a powder metering system and a roller mechanism, electrostatic deposition on a transfer surface followed by deposition to a build surface, and electrostatic deposition to a roller mechanism followed by deposition to the build surface. Infusion of a photocurable material (e.g., resin) may be achieved through infusion through the body of the component being built via a specialized infusion build platform.

Layer imaging may be achieved through several means, including but not limited to bulk imaging with a programmable planar light source, such as a DLP projector, wherein a refractive pixel shifting system is utilized to increase the effective resolution of the projection system.

Further, in one aspect a solid freeform fabrication device is provided such that composite objects composed of particulate material and resin material may be produced from digital data representative of a given three-dimensional object.

In another aspect, a SFF device is provided which utilizes bulk deposition techniques for production of layers of material.

In another aspect, a SFF device is provided which combines particulate material with photocurable resin material for production of composite layers of material.

In another aspect, a SFF device is provided which allows for interchangeability of material components to enable the use of a wide variety of material combinations.

In another aspect, a SFF device is provided which achieves production of composite layers through in situ infusion of powder layers through an infusion build platform.

In another aspect, objects produced from an SFF device may be treated thermally, chemically, or mechanically to improve internal adhesion of material components.

In another aspect, treatment may include pressurization in a fluid chamber, exposure to a solvent, elevation of temperature to facilitate bonding of particulate material, elevation of temperature to relieve internal stresses derived from the build process, or partial sintering of particulate material followed by infusion with a tertiary material, which may include a ceramic and/or metal material with a lower melting point than the primary particulate material.

In another aspect, a feedback system may be used to optimize the rate of material deposition.

In another aspect, a powder metering system may be used in tandem with a feedback system to optimize the rate of material deposition.

Further features of the subject invention will become more readily apparent from the following detailed description of the invention taken in conjunction with the accompanying drawings.

### BRIEF DESCRIPTION OF THE DRAWINGS

Preferred embodiments of the subject invention will be described hereinbelow with reference to the drawings, wherein

FIG. 1 is an elevated perspective view of a machine for solid freeform fabrication according to an embodiment of the presently disclosed subject matter.

FIG. 2 is an elevated perspective view of a powder deposition module as depicted in the machine in FIG. 1.

FIG. 3 is an exploded view of the module in FIG. 2.

FIG. 4 is a perspective section view from above of the module in FIG. 2.

FIG. 5A is a schematic depiction of the powder metering system used in the module in FIG. 2 in a first configuration.

FIG. 5B is a schematic depiction of the powder metering system used in the module in FIG. 2 in a second configuration.

FIG. 6 is a perspective section view from below of the module in FIG. 2.

FIG. 7 is a perspective view from above of an alternate embodiment of a powder deposition module for use in the machine in FIG. 1.

FIG. 8 is a schematic depiction of a second embodiment of the module in FIG. 2.

FIG. 9 is a schematic depiction of a third embodiment of the module in FIG. 2.

FIG. 10 is a schematic depiction of a fourth embodiment of the module in FIG. 2.

FIG. 11 is a schematic depiction of a fifth embodiment of the module in FIG. 2.

FIG. 12 is an elevated perspective view of the build platform of the machine in FIG. 1.

FIG. 13 is a perspective view from below of the build platform in FIG. 12.

FIG. 14 is an exploded view of the build platform in FIG. 12.

FIG. 15 is a section view of the build platform in FIG. 12.

FIG. 16 is an elevated perspective view of the resin distribution component of the build platform in FIG. 12.

FIG. 17 is an elevated perspective view of a projection module of the machine in FIG. 1.

FIG. 18 is a schematic diagram of the pixel shifting system of the projection module in FIG. 17.

FIG. 19 is an elevated perspective view of a second embodiment of the projection module in FIG. 17.

FIG. 20 is an elevated perspective view of a Digital Micromirror Device component of the projection module in FIG. 17 in a first configuration.

FIG. 21 is an elevated perspective view of a Digital Micromirror Device component of the projection module in FIG. 17 in a second configuration.

FIG. 22 is an elevated perspective view of a second embodiment of a Digital Micromirror Device component of the projection module in FIG. 17.

FIG. 23 is a top view of an imaging area corresponding to the Digital Micromirror Device in FIG. 20 in a first configuration.

FIG. 24 is a top view of an imaging area corresponding to the Digital Micromirror Device in FIG. 20 in a second configuration.

FIG. 25 is a top view of an imaging area corresponding to the Digital Micromirror Device in FIG. 20 in a third configuration.

FIG. 26A is an elevated perspective view of a component that may be produced with the machine in FIG. 1.

FIG. 26B is a perspective view from below of the component in FIG. 26A.

FIG. 27 is a top view of an imaging area corresponding to the fabrication of a first section of the component in FIG. 26A.

FIG. 28 is a top view of an imaging area corresponding to the fabrication of a second section of the component in FIG. 26A.

FIG. 29 is a top view of an imaging area corresponding to the fabrication of a third section of the component in FIG. 26A.

FIG. 30A is an elevated perspective view of the component in FIG. 26A in a second configuration.

FIG. 30B is a section view of the component in FIG. 30A.

FIG. 31 is a schematic view of a process of increasing precision in the process implemented in the machine in FIG. 1 in a first configuration.

FIG. 32 is a schematic view of a process of increasing precision in the process implemented in the machine in FIG. 1 in a second configuration.

FIG. 33 is an imaging system which comprises an alternate method of imaging material in the process implemented in the machine in FIG. 1.

FIG. 34 is an alternate embodiment of the projection module in FIG. 17, relating to the system in FIG. 33.

FIG. 35 is a perspective view from below of the machine in FIG. 1.

FIG. 36 is an algorithmic flow chart depicting a method of error correction for the projection module in FIG. 19.

FIG. 37 is an algorithmic flow chart depicting a method of automatically adapting the system in FIG. 1 to different powder materials.

FIG. 38 is an algorithmic flow chart depicting a method of error correction to compensate for imperfections in a powder deposition process.

FIG. 39 is a perspective view from above of a build process of the machine in FIG. 1 involving support material to facilitate improved system throughput in a first configuration.

FIG. 40 is a perspective view from above of a build process of the machine in FIG. 1 involving support material to facilitate improved system throughput in a second configuration.

FIG. 41A is a perspective view from above of the part being built in FIG. 40.

FIG. 41B is a perspective view from below of the part being built in FIG. 40.

FIG. 42 is a perspective view form above of an automation system for handling the parts being built in FIG. 40.

FIG. 43 is a schematic depiction of a method of producing removable features from the parts being built in FIG. 40.

FIG. 44A is a perspective view from above of the part in FIG. 41A with vectors utilized in post-processing.

FIG. 44B is a perspective view from below of the part in FIG. 44A.

FIG. 45 is a perspective view from above of a set of parts and support material that may be built with the machine in FIG. 1.

FIG. 46 is an exploded view of the parts and support material in FIG. 45.

FIG. 47 is a perspective view from above of one section of the support material in FIG. 45.

FIG. 48 is an elevated perspective view of another embodiment of a powder metering system.

FIG. 49 is a first section view of the system in FIG. 48.

FIG. 50 is a second section view of the system in FIG. 48.

### DETAILED DESCRIPTION OF THE DRAWINGS

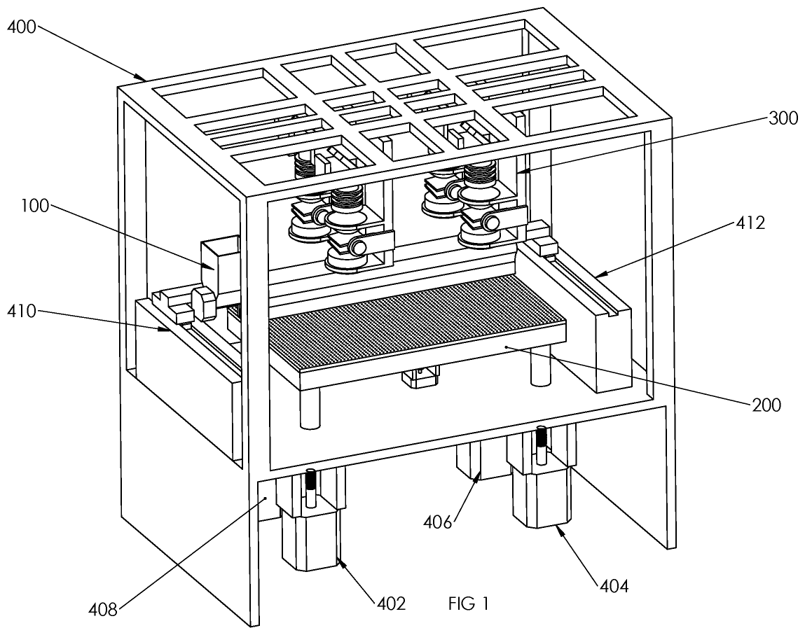

Resin Infused Powder Lithography (RIPL) is a technology based around three key processes: powder deposition, powder infusion, and imaging. FIG. 1 shows a machine (400) for SFF based on this technology, including a powder deposition module (100), a powder infusion platform (200), and an imaging system, which can be composed of multiple projection modules (300). The powder deposition module (100) moves across the powder infusion platform (200), such as via linear actuators (410, 412), depositing powder as it traverses the platform (200). The platform (200) is lowered, such as by vertical actuators (402,404,406,408), so that subsequent layers of material can be deposited to build up a three-dimensional object. A photocurable material, such as a resin, that is delivered from a supply system is infused into at least a portion of the deposited powder through the infusion platform (200), and the photocurable material is selectively irradiated using light emitted from the projection modules (300) to at least partially solidify a layer of a powder composite component. This builds a part in a layerwise fashion, the details of which will be elaborated hereinbelow.

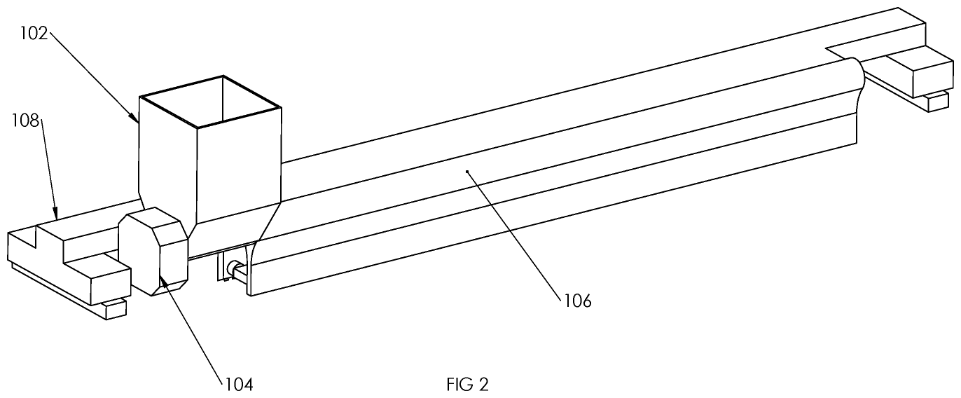

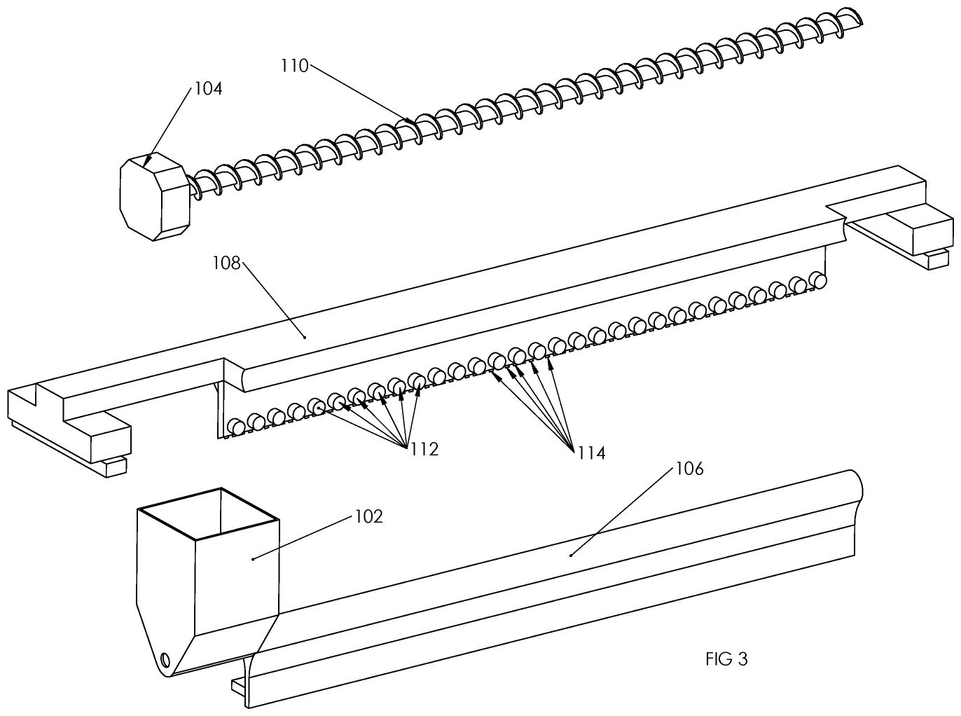

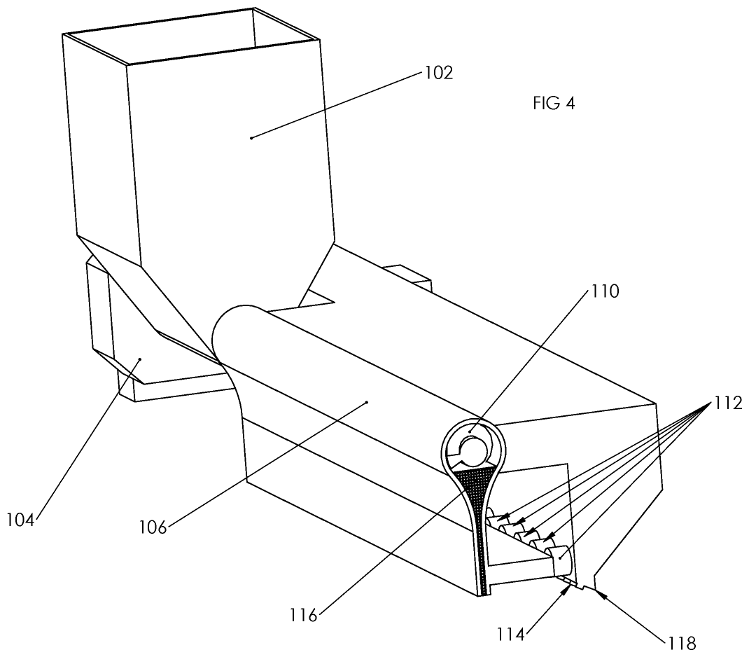

FIGS. 2-4 depict the powder deposition module (100) in more detail. The module (100) is composed of a powder hopper (102) from which powder (116) can be distributed. In some embodiments, the powder is drawn from the hopper (102) to a powder metering manifold (106) that is configured to distribute the powder (116) (e.g., dispersed substantially evenly) along the length of the module (100). In some embodiments, the powder manifold (106) extends linearly in a first direction and is configured to translate in a second direction, such as substantially perpendicular to the first direction, to distribute a layer of the powder material on the platform (200). In some embodiments, for example, a powder distribution screw (110) driven by a rotary actuator (104) is positioned in communication with the hopper (102) and the manifold (106). As can be seen in detail in FIG. 4, the powder distribution screw (110) brings powder (116) from the hopper (102) into the powder metering manifold (106).

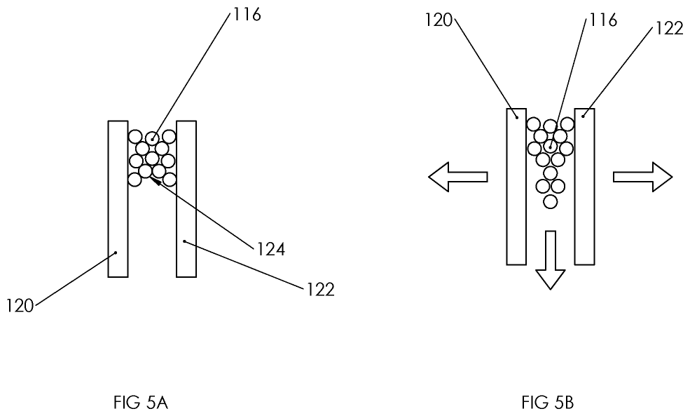

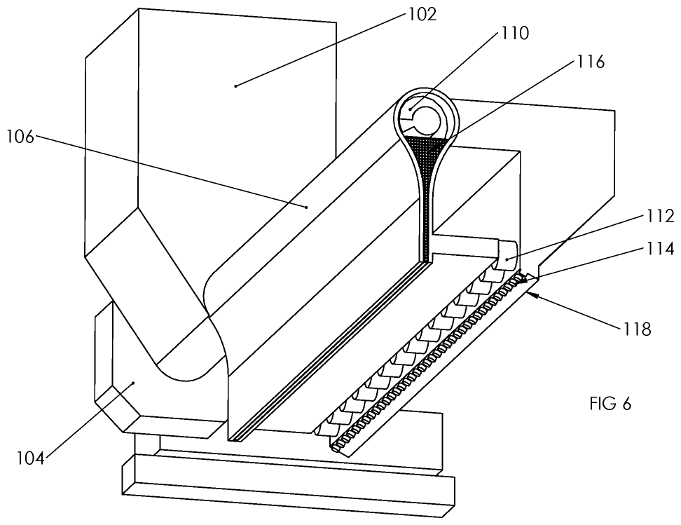

FIGS. 5A and 5B shows the manner in which powder (116) is metered from the manifold (106). The manifold (106) can include one or more narrow pathways, here defined by two parallel planar surfaces (120,122), which are configured to deliver the powder material to the build platform. Typically, when powder (116) is flowed through a narrow gap of this kind, an arch (124) forms and/or the movement of the powder is otherwise impeded (e.g., via electrostatic, van der Waals, or other force which may cause agglomeration, or other means), and flow is halted. If the defining surfaces (120,122) of the flow path are mechanically stimulated (e.g., oscillated laterally, as shown in FIG. 5B), this disrupts the arch (124) and allows powder (116) to flow freely. Alternatively, or in addition, the powder can otherwise be agitated to stimulate flow through the manifold. In any configuration, this kind of mechanical stimulation provides a mechanism for turning powder flow on and off. In this regard, in some embodiments, the powder (116) can be controllably metered from the manifold (106). Specifically, in some embodiments, one or more manifold actuators (112) can be configured to control the dispensing of powder from the manifold by agitating the powder material at or near at least one of the one or more narrow pathways to cause the powder material to flow through the respective at least one of the one or more narrow pathways. In some embodiments, powder accumulation sensors (114) can be used as a feedback source to this agitation. FIG. 6 shows an alternate view of the powder deposition module (100). The manifold actuators (112) can be operated to create the mechanical stimulation (e.g., lateral oscillation) previously described to allow free flow of the powder (116).

As the module (100) deposits a layer of powder, in some cases, the powder emerging from the manifold (106) may not be a uniform layer. A feedback system can be provided for measuring accumulation of powder as it is deposited, and the powder metering system can be controlled to vary distribution of the powder material based on input received from the feedback system. In some embodiments, a leveling device is used to planarize the powder material that is delivered to the powder infusion platform (200). For example, a doctoring blade (118) can be used to regulate the layer dimensions and flatness. Powder (116) can accumulate on the blade (118) during this process, and this accumulation may be sensed by accumulation sensors (114). This arrangement acts as a feedback mechanism to regulate the degree of stimulation that the manifold (106) is subjected to by the actuators (112). Minimal buildup on the blade (118) is desirable to optimize deposition speed and to minimize wear on the blade (118). This feedback mechanism may be based on the capacitive sensing of the proximity of conductive powder, contact-based sensing, or any other known method of detecting the presence of a given material. In an alternative embodiment, the blade (118) may in general be replaced by a counter-rotating roller or any other known means of regulating a layer of deposited powder.

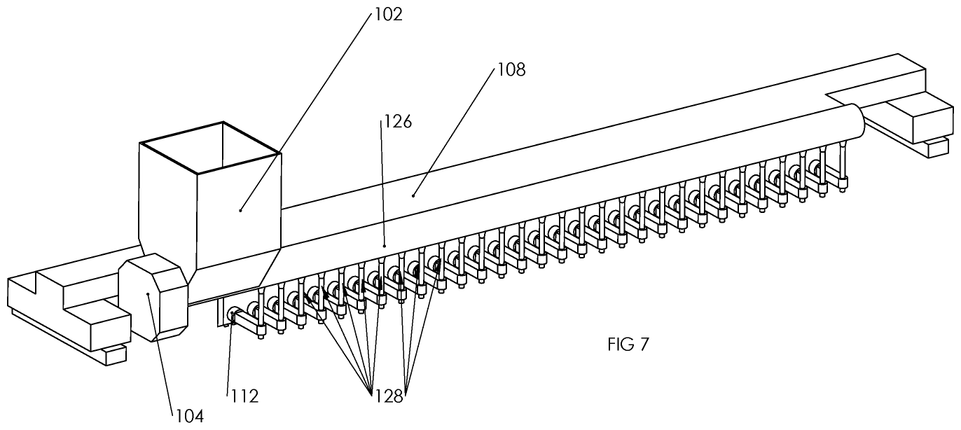

FIG. 7 shows an alternate embodiment of the powder deposition module (100), with the key difference of utilizing multiple needle-like nozzles (128) in communication with a powder distribution manifold (126). This will deposit multiple lines of powder, rather than a planar deposition structure, but can be converted to a uniform layer of powder by a doctoring blade (118), counter-rotating roller, or any of a variety of other means known to those experienced in the art.

These embodiments are intended as representative examples and not to restrict the breadth of the present disclosure. In general, this disclosure is intended to include the use of any container with an elongated opening that is structured such that either the opening itself provides a powder flow valve, or the opening is obstructed with such an object as provides a powder flow valve, wherein a powder flow valve is any flow path that obstructs powder flow when undisturbed or inadequately stimulated, and which permits powder flow when subjected to adequate mechanical stimulation, and the traversal of a build surface with this container provides means for producing a layer of powder. To this end, a third embodiment may include the use of a powder container with an elongate slot at the bottom that is covered by a mesh screen, wherein the apertures of the mesh screen are appropriately sized to obstruct powder flow unless adequate mechanical stimulation is provided. This embodiment is an extension of the needle system described previously, in that it uses a plurality of apertures of appropriate size as a powder valve system.

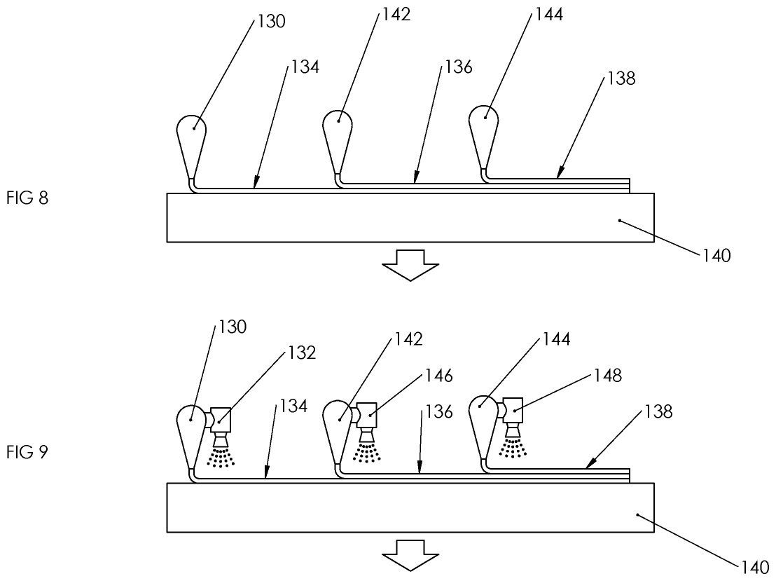

FIGS. 8-11 depict multiple means of increasing the operation speed of material deposition as previously discussed. Here, schematic representations of previously discussed components are used. Multiple powder deposition modules (130,142,144) may be used to deposit layers of powder (134,136,138) in succession, with their deposition processes overlapping to increase overall system operation speed.

FIG. 8 shows multiple layers deposited in sequence, with the deposition modules (130,142,144) at different heights to accommodate the thickness of each layer. This will improve system operation speed but has the disadvantage of possibly requiring both horizontal and vertical motion control for the deposition modules (130,142,144).

While alternate means of infusion have been previously mentioned and will be discussed with additional figures, FIG. 9 shows one means of infusing resin into powder. Spray modules (132,146,148) may be used to eject droplets of resin toward the powder substrate, effectively infusing the powder completely with resin. In this method, the droplets of resin may be electrostatically charged in order to facilitate electrowetting behavior to expedite the infusion process. In some embodiments, powder deposition may be achieved by a volatile suspension of powder particles in a fluid medium (e.g., a polar solvent), wherein the fluid is immiscible with the resin binder used to infuse the powder, and the fluid evaporates immediately following deposition (e.g., within 1 second or less), leaving the powder particles behind. This suspension may be deposited via an extrusion or spray method.

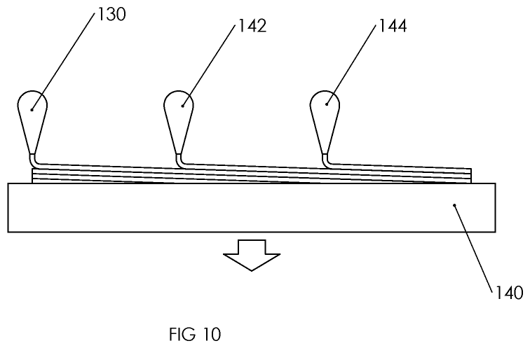

FIG. 10 shows an alternate means of using multiple deposition modules (130,142,144). In this implementation, layers are produced while the build platform (140) moves downward such that its motion is synchronized with the lateral motion of the deposition modules (130,142,144). This produces diagonal layers but does not require vertical actuation of the deposition modules (130,142,144). In either implementation, imaging methods may be implemented to compensate for the position of material with respect to the part being fabricated.

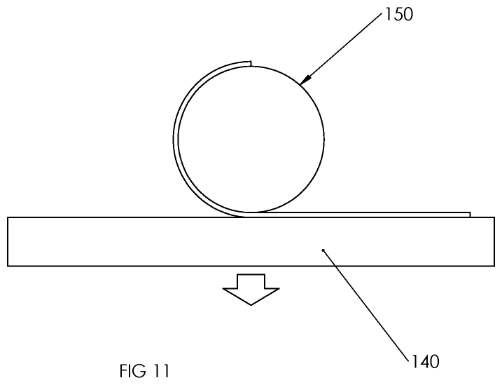

FIG. 11 shows an additional means of powder deposition; an electrostatic powder roller (150) may be used to deposit powder onto a build platform (140). In general, powder would be electrostatically applied to the roller (150) before transferring the powder to the build platform (140). Coating the roller (150) with powder may be done separately or synchrony with depositing powder on the platform (140). Electrostatic powder transfer is generally recognized as a high speed, high precision method of handling particulate material.

When utilizing electrostatic powder transfer, it is generally simpler to use non-conductive materials since surface charge is the primary means of particle manipulation. If metal powder is utilized in this system, there are several methods that may be used to facilitate electrostatic deposition. A polymer coating may be applied to the metal powder particles prior to deposition, thus providing an insulative surface to which surface charges may be applied. This coating may be removed during post-processing. Additionally, powder particles may be oxidized to produce an oxide layer at the surface which is insulative and allows for electrostatic powder transfer. Thermal processing in a reducing atmosphere, or other reducing means may be used to eliminate this oxide layer after powder deposition takes place. One additional method of removing the oxide layer would be the use of an acidic resin that reacts with the oxide layer and removes it during infusion.

In any implementation, an electric charge may be applied to powder as it is deposited to facilitate electrowetting behavior to expedite the infusion process. This will in general function with conductive powder but may be used with insulative powder and conductive resin as well.

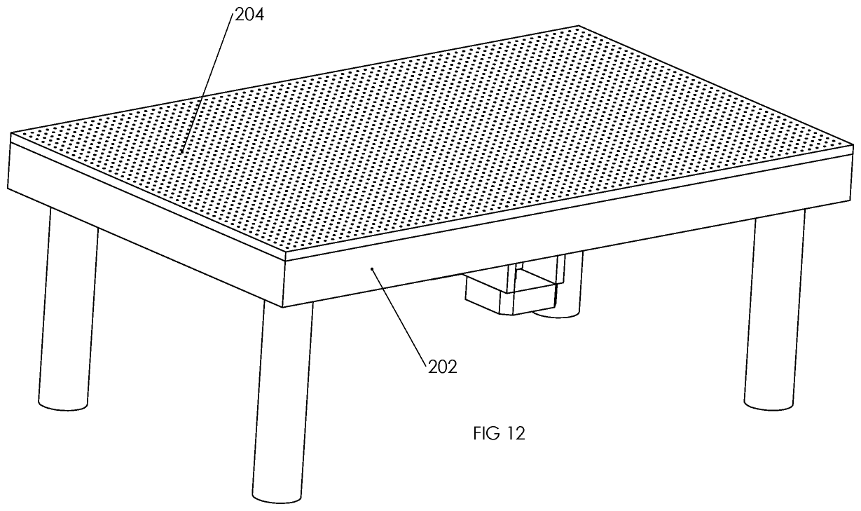

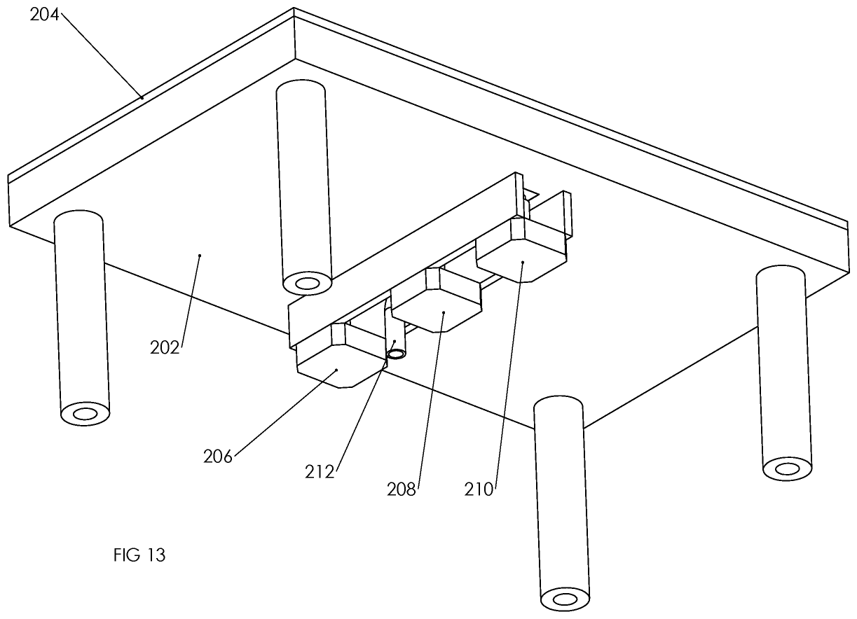

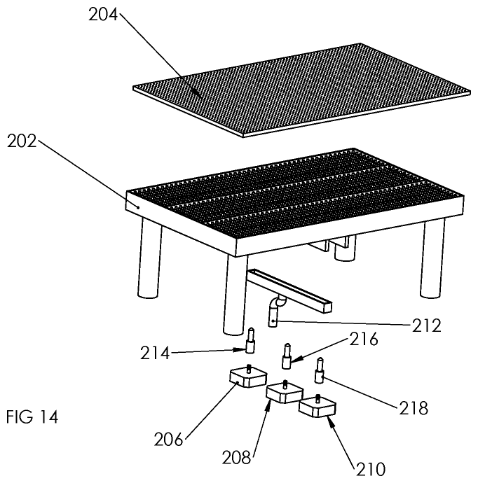

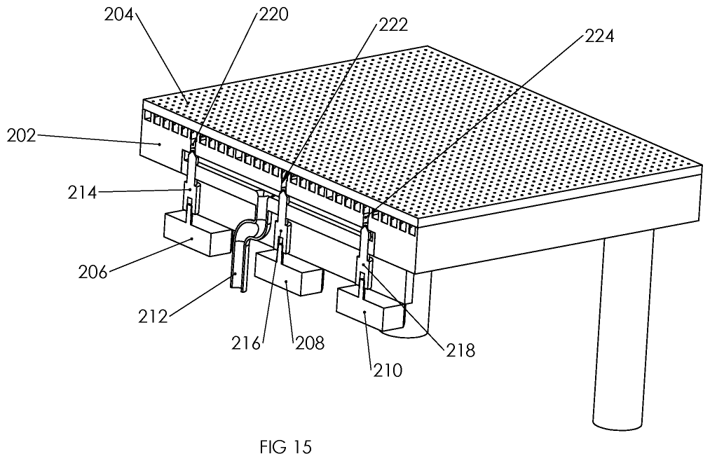

FIGS. 12-16 show the powder infusion platform. This is the platform on which a three-dimensional object is built. In the illustrated configuration, the platform is composed of a base (202), porous working surface (204), flow control actuators (206,208,210), flow inhibitors (214,216,218), and resin input manifold (212). After powder is deposited on the working surface (204), resin is supplied to the resin input manifold (212). Resin may then flow into three regions of the base (202) through three ports (220,222,224). In some embodiments, the flow through these three ports (220,222,224) is controlled by the three flow inhibitors (214,216,218). The position of the flow inhibitors (214,216,218) may be controlled by the three flow control actuators (206,208,210). The base (202) has an array of pin features that support the working surface (204) while much of the remaining volume within the base (202) is left open, allowing free flow of resin to all areas of the working surface (204). In this regard, the pin features provide structural stability to the working surface (204) without inhibiting the dispersion of the resin through the base (202). In the particular embodiments illustrated in FIGS. 12-16, for example, the base (202) effectively provides three large open cavities that are each associated with one of the three ports (220,222,224).

This arrangement functions as a multi-channel needle valve system to control resin flow. While three distinct fluid paths are shown here, any number may in general be implemented, in any configuration which supplies resin in a controlled manner to the working surface (204). While the three regions of the base (202) and working surface (204) that correspond to the flow of resin at three input ports (220,222,224) are largely separate, the structure of the base (202) may in general be designed to allow intermingling regions of independently controlled flow. The flow may be controlled by a single source with multiple modulating valves, as in this implementation, or may utilize any number of pumping sources and modulating valves.

Additionally, a vacuum pressure may be applied to the build area, while the resin source is kept at atmospheric pressure. This differential pressure may be the primary means of providing resin flow, while modulating valves control flow at precise regions within the build process. Further, the use of a vacuum within the build area may aid in powder deposition, as small powders that are used for high precision fabrication have a tendency to self-aerosolize when agitated. Further, resin may be gravity-fed via a supply hopper that is external to the working volume. Static pressure (derived from the height of a gravity-feed vessel), vacuum pressure, and applied pressure via a pump system may be used in any combination to deliver resin in the build process.

Regardless of the particular configuration, the working surface (204) is porous, and allows resin to flow through it and into a powder layer deposited on it. This resin can be cured with light, fixing the powder in a specific geometry in order to build a three-dimensional object. The precise means of curing the resin and building an object in a layerwise fashion will be described in additional detail. In general, part or all of this platform system may be removable from the fabrication apparatus in order to facilitate palletized fabrication, where the results of one build process may be post-processed while another build process is being conducted.

In all previously discussed embodiments, the fabrication process comprises the steps of powder deposition and powder infusion with a photocurable resin. The combination of powder and photocurable resin places some constraints on the composition of this resin, depending on the optical properties of the powder being used. In general, optical penetration into the composite material will be lower than in conventional stereolithography resins, given the presence of powder as an optical inhibitor. To improve curing of the photocurable material, in some embodiments, the photocurable material includes at least one resin material including at least a reactive monomer or oligomer, and the photocurable material can further include a photoinitiator that is configured for polymerizing the monomer or oligomer component when subjected to stimulation by irradiation. Resins used with this system may in general contain monomers of any of several types, including but not limited to acrylates, monomers and/or oligomers of polyethylene, monomers and/or oligomers of polypropylene, or others. Resins used with this system may utilize photoinitiators to initiate a free radical and/or cationic polymerization reaction, but in the use of metal powders will likely include a mass concentration of photoinitiator greater than 1%, which can help to compensate for the presence of the powder as an optical inhibitor. In some embodiments, for example, a mass concentration of photoinitiator can be between about 1% and about 50%. In some particular embodiments, mass concentrations in a range of between about 3% and about 35% provide a composition that is effective in overcoming the optical inhibition by the powder, with ranges between about 5% and 20% providing a balance between maximizing powder volume and improving the initiation of free radical and/or cationic polymerization.

In many cases, it is desirable to process parts built using this method by sintering the powder into a solid object. In these instances, additives may be included in the resin formulation to aid in post-processing. In other composite fabrication processes that use thermal post-processing to sinter a powder composite part into a solid monolithic component, such as Metal Injection Molding (MIM), there is often a debinding step in which most of the binder is removed before the part is sintered. These debinding processes typically involve one of three methods; catalytic debinding, solvent debinding, or thermal debinding.

In a catalytic debinding process, the resin material includes a component that is removable using a catalytic decomposition process, and the photocurable material generally or the reactive monomer or oligomer particularly is non-reactive with the catalyst used in the catalytic decomposition process. In some embodiments, nitric acid vapor is used to remove one component of a hybrid binder, which is typically comprised of acetal homopolymer and an olefin. The acetal is removed by the nitric acid, leaving behind an olefin binder which may be removed during sintering. In a solvent debinding process, the resin material includes a component that is soluble in a solvent in which the photocurable material is not soluble. In some embodiments, a hybrid binder is again used, where one component is soluble in a particular solvent, which removes that component during debinding. A common implementation of this method is a blend of acetal and polyethylene glycol (PEG). The PEG is soluble in water and is typically removed in a hot water bath during debinding. In a thermal debinding process, the resin material includes an added component having a first melting point that is lower than a second melting point of the photocurable material generally, and the process is performed at a temperature above the first melting point. In some embodiments, a hybrid binder is again utilized, where one component is typically a low melting point wax, which may be melted out during the debinding process. In general, any binary binder system in which the two components have significantly different melting points may be used for a thermal debinding system.

In the process utilized in any of the previous embodiments, similar hybrid materials may be used. For example, monomers or oligomers of acetal may be incorporated into an acrylate resin blend, in order to produce a hybrid material which may be partially removed from a printed component using nitric acid vapor. In general, any material blend that includes at least a photoinitiator, monomers and/or oligomers of a reactive photopolymer, and another component which may be removed with a catalytic decomposition process, will be effective for debinding using this method. It may also be possible to use a photopolymer which is susceptible to catalytic decomposition, along with a component which is liquid at the operating temperature of the fabrication system, and solid at a temperature at which catalytic decomposition can take place.

Similarly, a hybrid material composed of at least a photoinitiator, monomers and/or oligomers of a reactive photopolymer, and another component which is soluble in a particular solvent, in which the cured photopolymer is not soluble, may be used to produce components which may be treated in a solvent debinding process. Additionally, a photopolymer that is soluble in a particular solvent may be used along with a component which is liquid at the operating temperature of the fabrication system, and solid at a temperature at which solvent debinding takes place.

Similarly, a hybrid material composed of at least a photoinitiator, monomers and/or oligomers of a reactive photopolymer, and another component which has a lower melting temperature than the cured photopolymer may be used in a thermal debinding system, wherein the fabrication process is run at a temperature higher than the melting point of the added component, and excess material is removed prior to lowering the temperature of the fabricated part for handling and further post-processing.

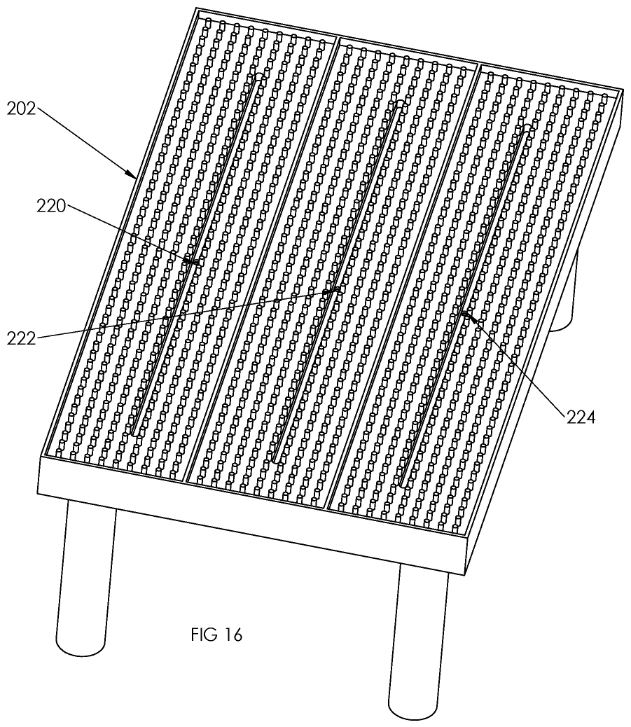

FIG. 17 depicts a projection module (300). The module is composed of a display unit (302), collimation lens (306), refractive pixel shifters (308,310), and decollimation lens (312), mounted on a base (304). As is shown schematically in FIG. 18, the display unit (302) projects an image, composed of multiple pixels nominally emanating from a singular point. The beams that form these pixels are collimated by the collimating lens (306) such that all beams are parallel. These parallel beams can be shifted with extremely high precision by rotating a refractive pixel shifter (308) a specified angle. It is known that light passing through an object of higher index of refraction than the surrounding medium will be shifted laterally by an amount dependent on the index of refraction, thickness, and angular position of that object; this system, in contrast to standard reflective pixel shifting systems, can readily achieve nano-scale precision in the displacement of pixels on a projection surface. This system enables ultra-high precision digital fabrication to a significantly greater extent than any previous imaging system. In the embodiment illustrated in FIG. 17, the projection system (300) uses two pixel shifters (308,310) such that the image may be shifted by any amount within the projection plane. The first refractive pixel shifter (308) can be pivotable about a first rotation axis, and the second refractive pixel shifter (310) can be pivotable about a second rotation axis that is different than the first rotation axis. In some embodiments, the second rotation axis is substantially perpendicular to the first rotation axis. Regardless of the particular configuration, the one or more beam of radiation is transmitted through the refractive pixel shifters (308, 310) to produce one or more exigent beams of radiation directed toward the projection surface. The decollimation lens (312) focuses the image to the desired size on the projection surface.

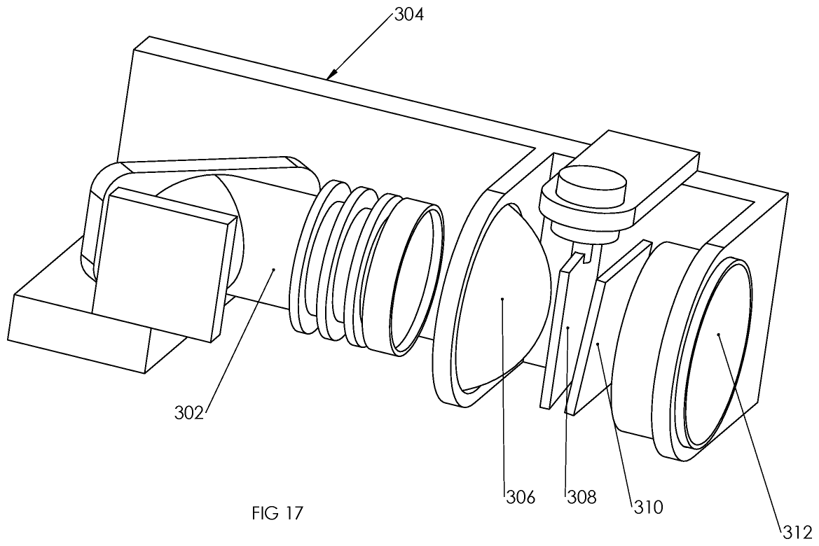

An alternate implementation of this projection system is shown in FIG. 19. In this version, the collimation (306) and decollimation (312) lenses are omitted. This has the disadvantage of not collimating the image prior to shifting it, which will result in a non-uniform shifting effect. This may be compensated for in software by mapping the pixel shift effect in order to determine an inversion function. This inversion function takes as input the physical location of any pixel on the imaging surface and calculates the corresponding position of the pixel in the image produced by the display unit (302) prior to the shifting effect. This function may be applied to CAD data in order to determine the required images that must be projected and shifted in order to build a given object.

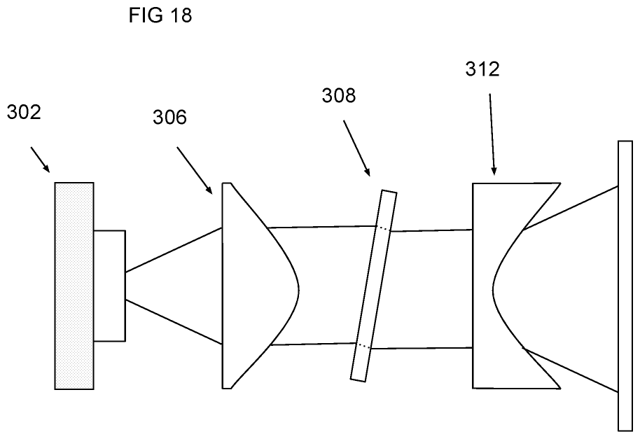

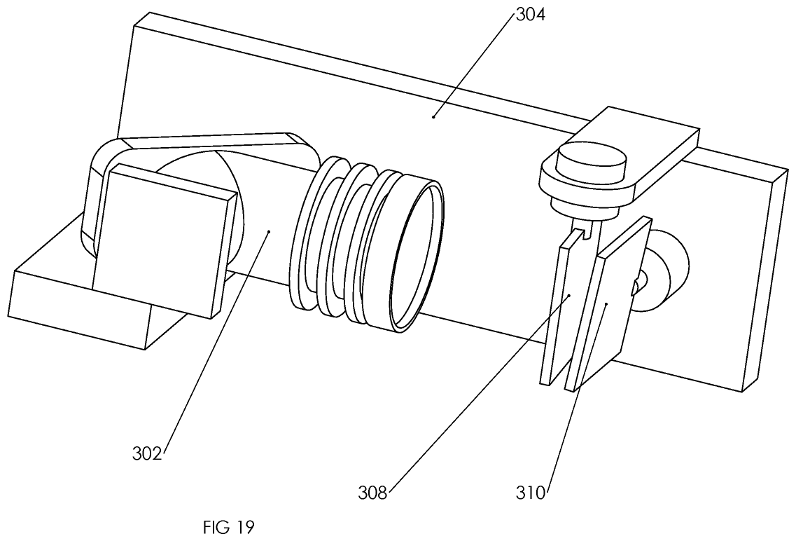

FIGS. 20-22 depict several configurations and embodiments of a Digital Micromirror Device (DMD). A DMD is the key element in a display unit (302). The micromirrors (320), mounted on a chip (322), can be in an “on” state as in FIG. 20, or an “off” state as in FIG. 21. A light source provides incident beams of light to the DMD, which are either reflected at an angle to allow them to escape the display unit (302) if they are in the “on” state or are reflected into a light absorber if they are in the “off” state. By selecting individual mirrors to be in the “on” or “off” states, an image may be projected. In some implementations of the present system, it may be desirable to only have a central region (324) of each pixel (320) be reflective, as in FIG. 22.

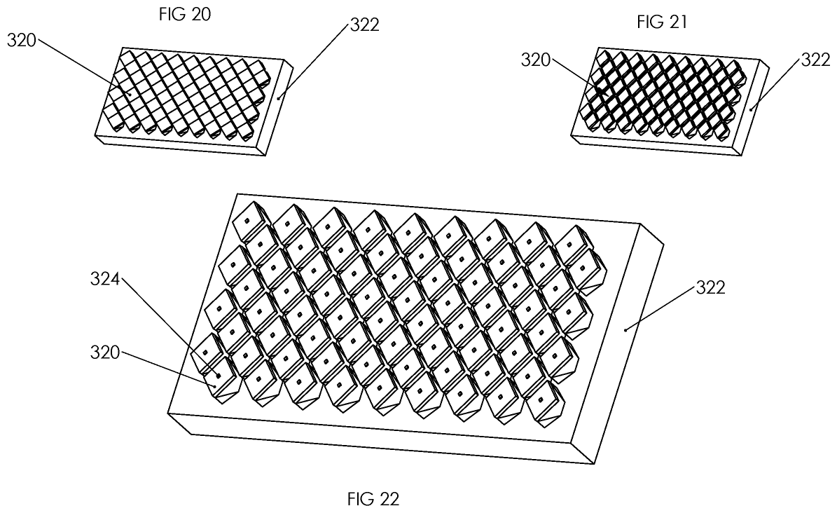

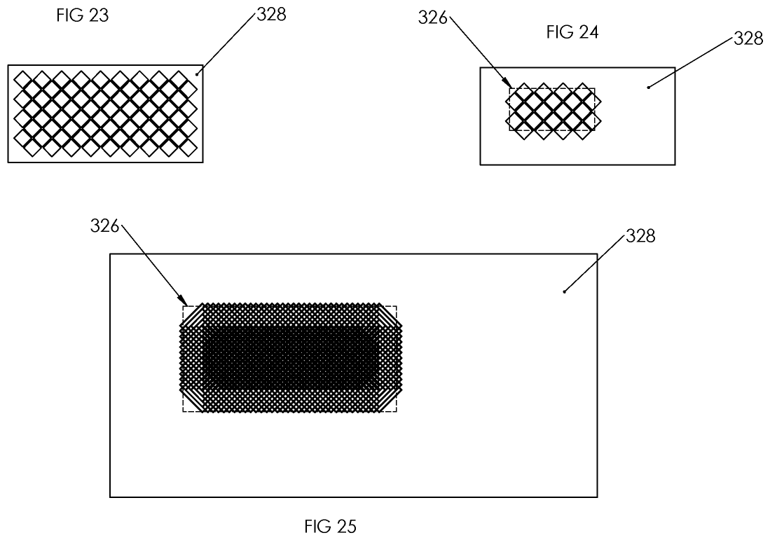

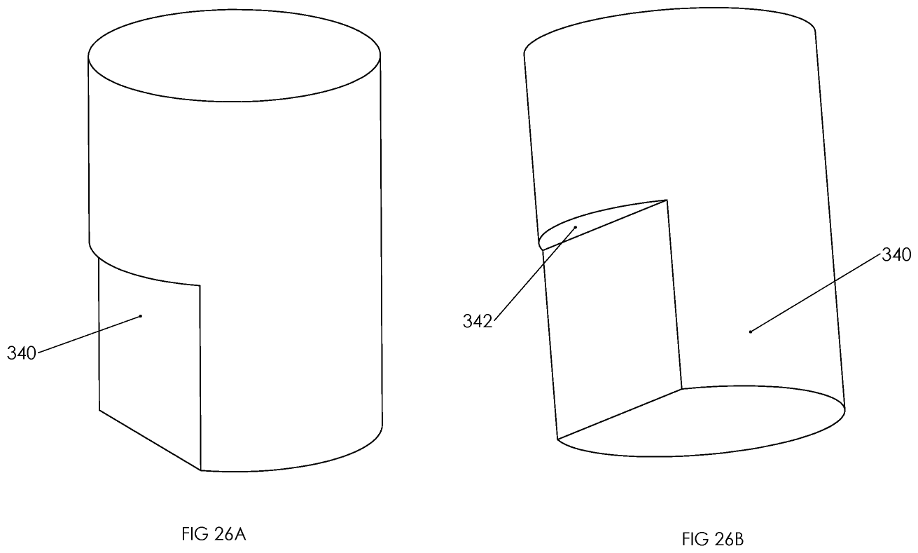

FIGS. 23-25 show a projection surface (328) subjected to several of the previously described imaging systems. FIG. 23 shows the effect of having all pixels in an “on” state. If a rectangular region (326) is the desired image, then only the pixels shown in FIG. 24 will be in the “on” state. This doesn't accurately represent the rectangular region (326), and so pixel shifting may be utilized to achieve a more realistic representation. FIG. 25 shows the effect of performing multiple exposures, shifting pixels between each exposure, in order to more accurately image the rectangular region (326). While this makes the edges of the region more well defined (i.e., capable of filling the space between pixel edges to produce surface features having an effective resolution that is more precise than the level of precision that is inherent in the size of the pixels), it does not completely resolve aberrations at the corners; this would be one instance in which the DMD system described in FIG. 22 would provide some advantage. A similar advantage may be achieved by spacing the micromirror units farther apart on a DMD chip and focusing the resulting image to a smaller area. The overall effect would be to have an array of small pixels, spaced apart by a distance that is typically larger than their width, shifted to collectively completely image a target region.

FIGS. 26A and 26B depict an object which may be built using the previously described systems. It includes a cylindrical body (340) and an overhang (342). As was previously mentioned, powder will be spread on a platform and infused with resin, such that all interstitial spaces are occupied with resin. The resin will be cured using light, to form cross sections of a desired object, such that the aggregate form of all cross sections is the desired object. This presents an obvious constraint; resin from one layer of an object is restricted form infusing a subsequent layer by any portion which is cured by the imaging system.

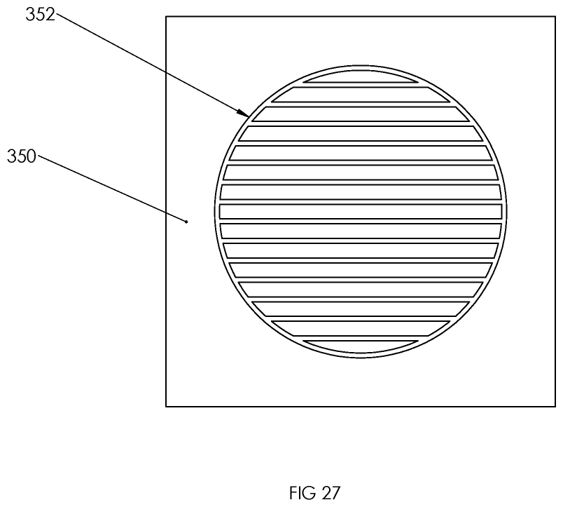

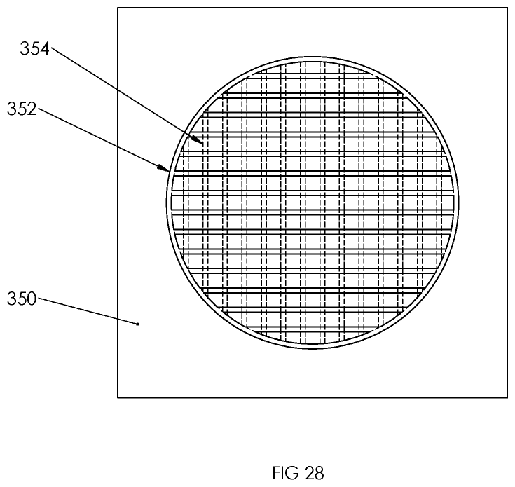

FIGS. 27-32 depict means of mitigating this effect and utilizing this effect to improve system performance. While curing a solid cross section could present a significant restriction to resin flow, a lattice structure can be utilized (352) which bonds powder together and still allows resin to flow to subsequent layers. FIG. 27 shows a layer of the object in FIG. 26A being built by the described system. The first component of a lattice pattern (352) is projected to a build area (350) to produce this layer. After additional powder is deposited and infused with resin, a second component of a lattice pattern (354) is projected to the build area (350). These two components may be projected in alternating layers to build a lattice structure. In general, any structure which binds together powder securely while still permitting resin flow to subsequent layers of powder may be utilized.

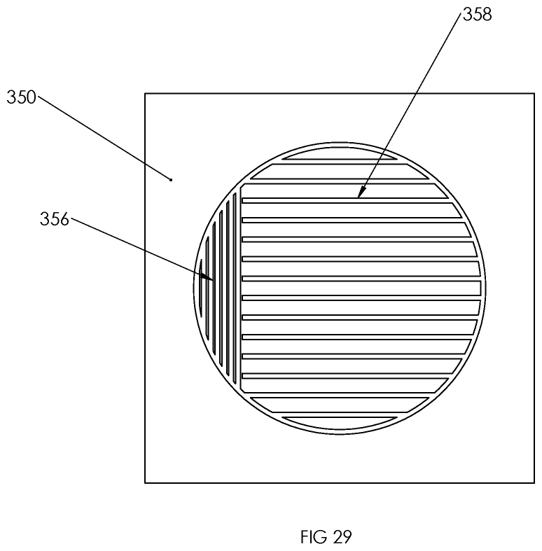

FIG. 29 shows one possible method of producing the overhang feature (342) of the object (340) being built. A denser region of the lattice pattern (356) may be used for the down-facing surface of the overhang feature (342) while a lower density lattice pattern (358) is used for the other sections of this layer. If the gaps in the higher density section (356) are smaller than the particulate diameter, then powder will be bound in a solid layer, even as there are still interstitial spaces left uncured for resin to flow through into subsequent layers. This denser region (356) provides a flow constraint that is more restrictive than the lower density region (358), which may be managed as described below.

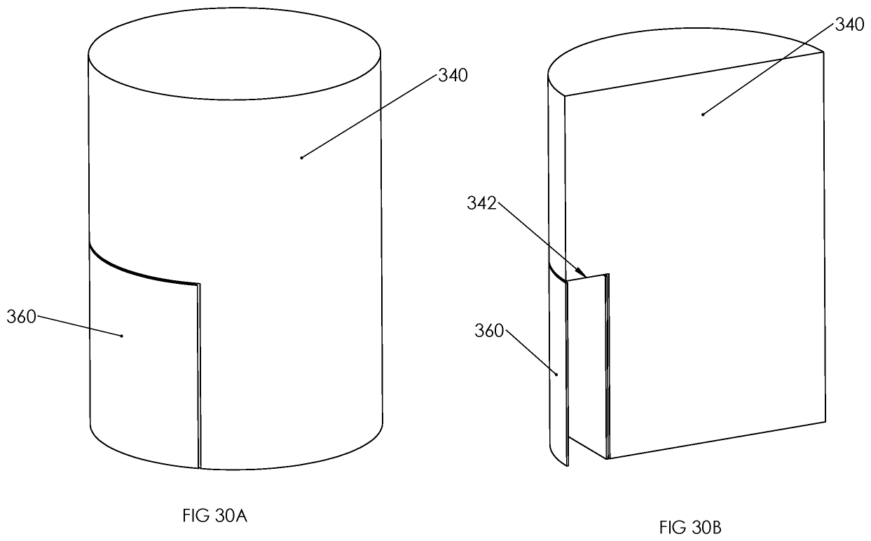

FIGS. 30A and 30B show one method of compensating for the flow restriction presented by a down-facing surface. A skin (360) may be built underneath the surface (342), in order to guide resin flow into the surface (342). Depending on the construction of the infusion platform (200), the pressure of the flow through this skin (360) may be controlled independently of the pressure of the flow through the object (340) itself. Thus, the flow rates may be equalized through differential pressure control.

Parts produced through this technique may be processed through thermal, chemical, or mechanical treatment to remove the resin binder and condense the powder material into a solid. The most common technique to achieve this effect is sintering. In many instances, sintered objects are produced with metal or ceramic powder and a solid polymer binder and subjected to chemical or thermal treatment to remove most of the binder. This creates a porous binder structure so that the remaining binder can be removed uniformly during sintering. By virtue of creating a porous object during the build process, this chemical or thermal treatment process may be expedited or eliminated, thus improving overall process speed.

The method of defining distinct flow paths by curing flow control structures as shown in FIGS. 30A and 30B may be further extrapolated by providing multiple resin materials to different regions through different infusion zones in the build platform. In some cases, this technique may be used to produce oxidized metal particles at the boundary of an object being built, while leaving the particles within the object with minimal oxidation to facilitate sintering during post-processing. Oxidized metal particles do not sinter to each other at the temperatures that are used to sinter together non-oxidized metal particles, and as such, oxidation may be used as a means of separating regions of material which will bond internally during sintering, but not bond across boundaries defined by oxidized particles. This may be used to fabricate complete assemblies with independently moving parts in a single build process, or to produce removable support material that will assist in stabilizing a part during the sintering process.

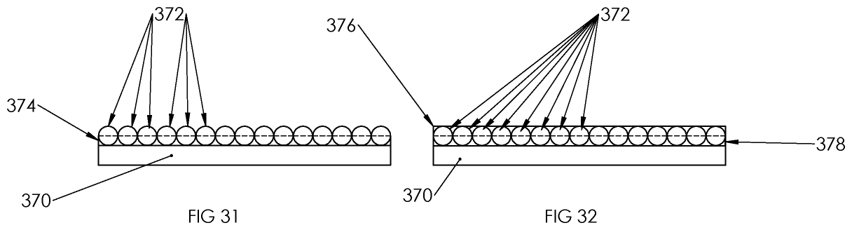

FIGS. 31 and 32 illustrate further advantages of this process. In many SFF processes, precision is largely constrained by the thickness of layers of material that are used in fabrication. As can be seen in FIG. 31, if material is cured before it fully infuses a layer of powder, fractional layers may in principle be achieved. The partially infused resin (374) may be cured to bind the powder (372). Similarly, cure parameters may be adjusted to limit cure depth, as shown in FIG. 32. A solidified region (376) may be produced that only penetrates partially into the layer of powder (372), leaving uncured resin (378) below. Thus, up-facing and down-facing surfaces that don't align perfectly with a given layer may be achieved. This method may also be used to improve the quality of contoured surfaces, and part precision in general.

In previously described implementations of the present system, an array of projection modules (300) were used to collectively fully image the build area. One of the advantages of the previously described pixel shifting system, is the multiplicative effect it has on system resolution while maintaining the size of the area imaged by a given module. This is particularly critical for systems where microscale and nanoscale image resolution is useful, but the objects being imaged are mesoscale or macroscale. In a system with these requirements, it can be difficult to focus a projected image to a size which has pixels small enough to produce the desired resolution, and even if this is possible, the resulting image would be much smaller than the physical size of the display unit. This makes an imaging array that can efficiently image the entire build area difficult or impossible. Being able to image the entire build area may be desirable for optimizing speed.

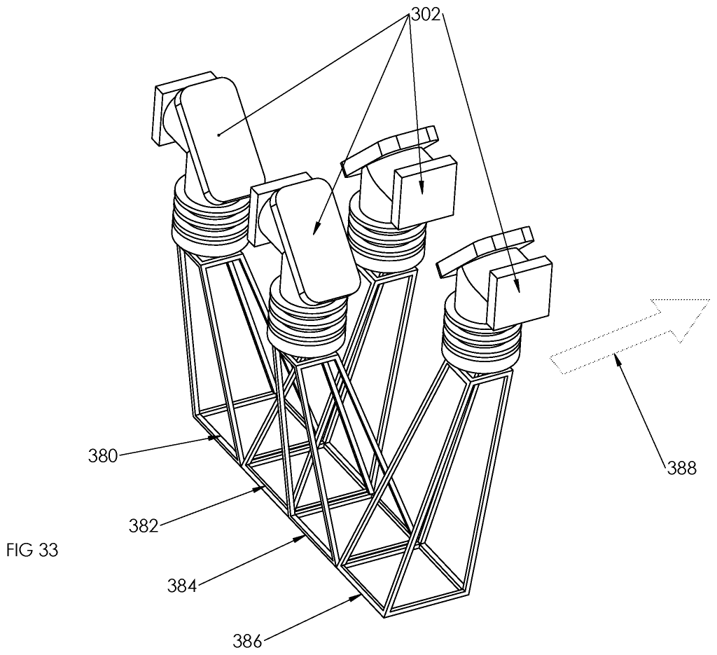

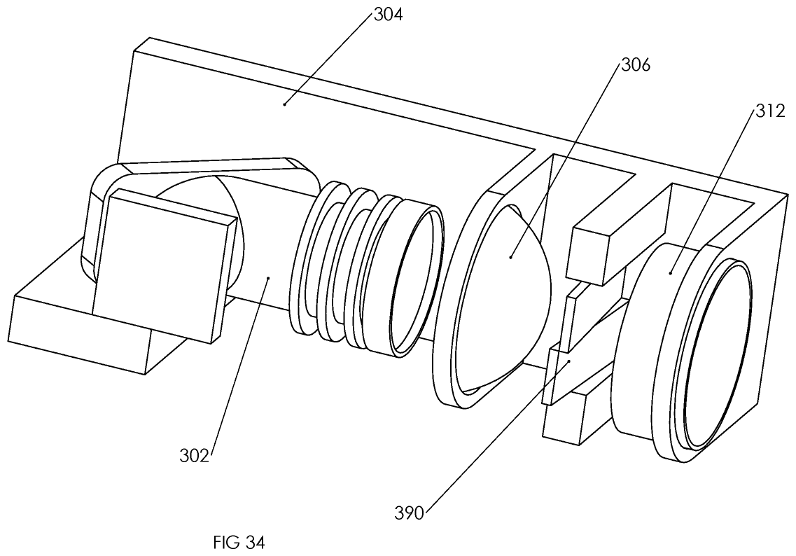

An alternate system consists of a linear array of display units that traverses the build area in a direction perpendicular to the array alignment. FIG. 33 shows one such array. This overcomes the problem of having a display unit larger than the projected image by projecting images (380,382,384,386) at an offset angle from the normal vector of the projection units (302). The array moves along the build area in the specified direction (388) in order to image the entire build area sequentially. In general, this operation may be done following the powder deposition, assuming infusion speed is high enough to keep pace with this process. Thus, in some implementations, powder deposition, infusion, and imaging may occur in rapid sequence as the powder deposition module and imaging array traverse the platform together.

In this instance, the focused resolution of the display unit is the effective resolution of the object being built. FIG. 34 depicts an alternate embodiment of the projection module (300) that adds precision to the method of traversing the platform with a linear array of modules. In this instance, a plurality of static refractive elements (390) are arranged at different angles relative to the surface onto which the image is projected. These static refractive elements (390) are used to split the image into sections that are shifted slightly with respect to one another. This increases the effective resolution of the system. An arbitrary number of refractive elements may be used, in order to achieve the desired resolution.

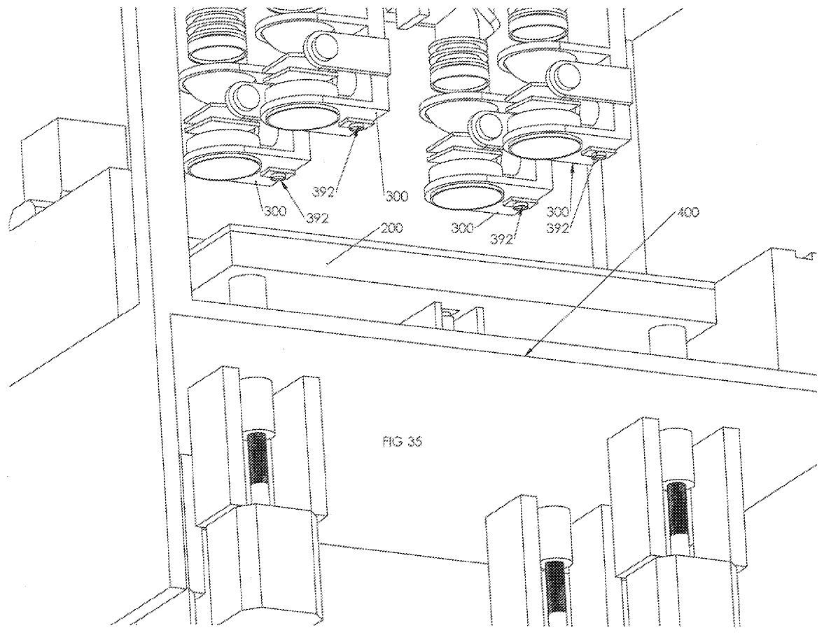

FIG. 35 shows an alternate view of the present embodiment. As previously discussed, the fabrication method implemented in this system involves the processes of depositing powder, infusing powder with resin, and curing the resin to a specified pattern. While infusion is somewhat automatic, being driven by capillary action, flow control may also be utilized as previously described with any of a variety of pumping systems. In this case, it is useful to have feedback to control the pumping system. Cameras (392) may be used for visual feedback to monitor the infusion process and control the resin supply system. The same hardware may also be utilized for fault detection and any of a wide variety of system automation applications, including but not limited to measuring layer topography via a structured light or laser scanning system, as well as calibration and synchronization of projection modules.

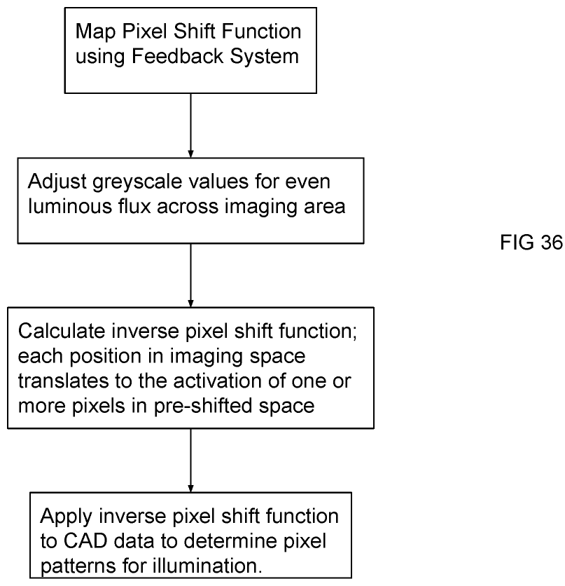

As previously discussed, multiple implementations of the projection module (300) may be utilized. In many of these, refractive pixel shifting is implemented. In some instances, the degree of pixel shifting is non-uniform or non-linear. In these cases, software calibration and compensation may be required to achieve optimal precision. FIG. 36 describes a method of compensating for any of these aberrations using a vision feedback system as described previously. First, the vision feedback system may be used to map out the location of all pixels for all projection modules at all possible shifted positions using the refractive shifting system. In places where pixels overlap excessively, greyscale values may then be determined to homogenize the degree of light intensity at all locations in the imaging area. From this mapping, an inverse pixel shifting function may be calculated or simply implemented as a reverse lookup table. This inverse function may then be applied to CAD data to determine the imaging parameters to produce a desired object.

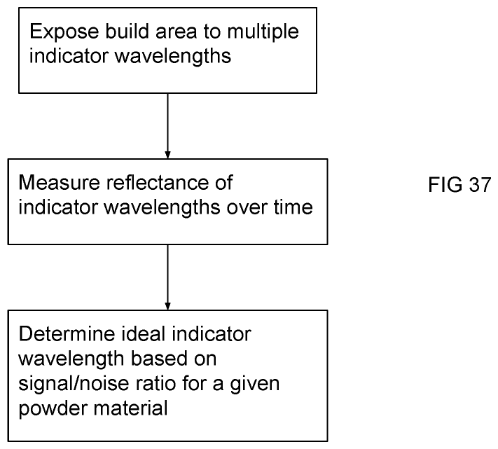

This fabrication system is generalizable to any of a variety of powder materials. The ability of a vision system to detect the degree of infusion of resin into a particular layer of powder material may vary somewhat with the optical properties of the powder in question. FIG. 37 shows a method of compensating for this behavior. The vision feedback system may in general sense a broad spectrum of wavelengths, and it may be advantageous to provide one or more illumination sources that produce one or more wavelengths that do not instigate a chemical response in the resin as indicators of infusion. For new powder materials, the optimal indicator wavelength may be determined by exposing the powder to each of a variety of potential indicator wavelengths during the infusion process. By measuring the change in reflectance and absorbance during infusion, the wavelength for which the largest change in behavior occurs may be selected in order to maximize signal/noise ratio.

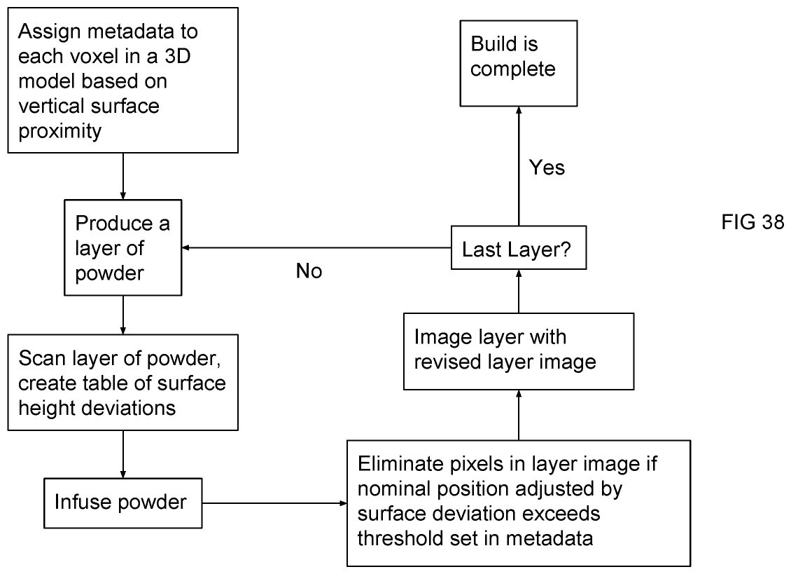

While many of the previously described powder deposition systems can produce highly uniform layers of powder with a high degree of reliability, it may be advantageous in some implementations to allow powder layers to deviate in their uniformity, and to compensate by measuring layers as they are produced and adjusting imaging data to compensate. This may allow powder deposition to occur without a doctoring blade (118) or other object for planarizing the powder layer, which may increase deposition speed. FIG. 38 describes one method of implementing this. Before fabricating an object, it may be split into 3 dimensional pixels, also called “voxels,” and each voxel may be analyzed for its proximity to a desired boundary of the component (e.g., an up-facing or down-facing surface). In general, aberrations in powder deposition are inconsequential unless they occur near an up-facing surface or down-facing surface. For example, if a portion of a layer has too much material, where the nominal height of this portion is at the location of an up-facing surface, the excess material would produce a surface that is higher than the nominal position. In order to avoid this, a rapid means of assessing actual layer topography and compensating for aberrations may be used.

As voxels are analyzed for their proximity to up-facing and down-facing surfaces, any voxels that are within a threshold distance to one of these surfaces may be assigned a value corresponding to the actual distance between this voxel and the surface in question. In general, a voxel may be assigned no values, one value (if proximate to one surface) or two values (if proximate to two surfaces, in the case of a thin horizontal feature). As layers of powder are produced, each layer may be scanned to assess its topography, and measure deviations of powder height from nominal height. When a layer is imaged, an array of pixels is generated based on the voxels included in the layer in question. Layer deviation measurements may be placed in a table corresponding to the locations of voxels in the layer being fabricated. Prior to imaging the layer, pixels in the layer image may be eliminated if measured deviations in the powder surface exceed the distance measurement corresponding to their originating voxel. Alternatively, the pixel array may be modified with metadata to be utilized in the previously described methods of fabricating fractional layers. In this manner, aberrations in the powder deposition process will not affect overall fabrication precision. As a result, such correction of layer deviations can minimize deviations from the desired structure (e.g., as defined by a CAD model).

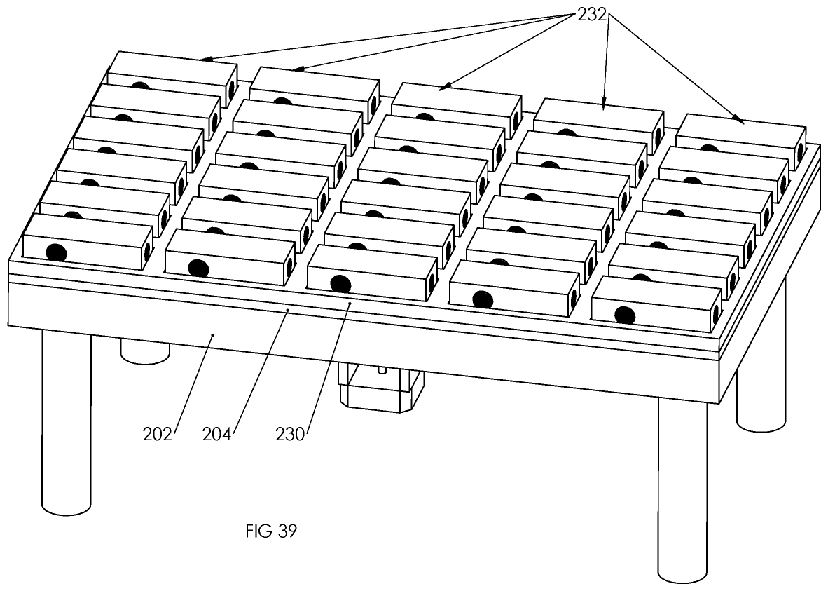

High throughput is required in order for digital fabrication to be utilized in mass production. In many circumstances, this requires printing batches of parts in order to maximize productivity. FIG. 39 shows one example of this. An array of parts (232) is printed on the working surface (204) on top of the platform base (202). In this figure, excess uncured resin and unbound powder have mostly been removed. This can be accomplished by any of a variety of washing systems involving spray apparatus and solvents that can dissolve uncured resin. Support material (230) has been fabricated to resist any shear forces exerted on the parts (232) during powder deposition. This support material (230) may or may not be required depending on the method of powder deposition, but in any case does not need to be connected to the parts (232). This non-contact support material (230) secures the parts (232) by its proximity to the parts (232) but does not interfere with parts handling during post-processing.

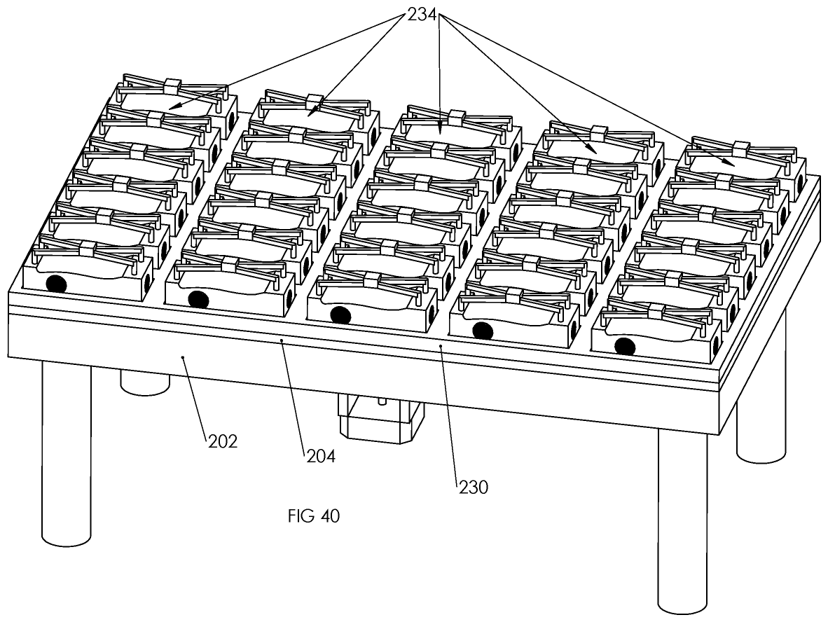

While removing excess material from on top and around a batch of parts is in general trivial, handling these parts requires additional automation systems. While the parts (232) previously shown have flat surfaces that facilitate handling via a vacuum gripper or mechanical gripper system, not all parts will have features that facilitate automated handling. FIG. 40 shows a batch of parts (234) with an uneven upper surface, which would not be readily handled by a standard vacuum gripper. Instead, additional features have been added to these parts facilitate manipulation.

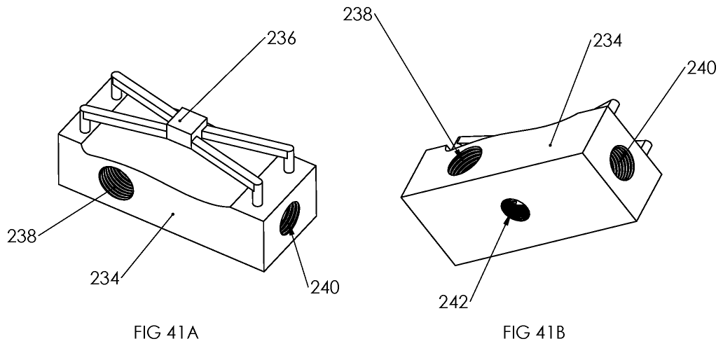

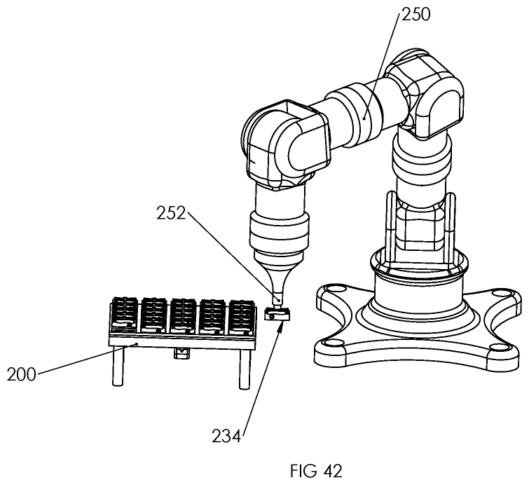

FIGS. 41A and 41B show the parts (234) with manipulation features (236) in more detail. These manipulation features provide (236) a flat surface which may be engaged by a vacuum gripper (252) as shown in FIG. 42, or by any other gripper driven by a pick and place system (250). The key operations for post-processing parts wherein the parts are composed of a metal or ceramic powder and the desired final product is a solid metal or ceramic part include removal of excess material, removal of manipulation features, and placement on a tray for sintering. There is significant value in automating these operations as they are typically very labor intensive.

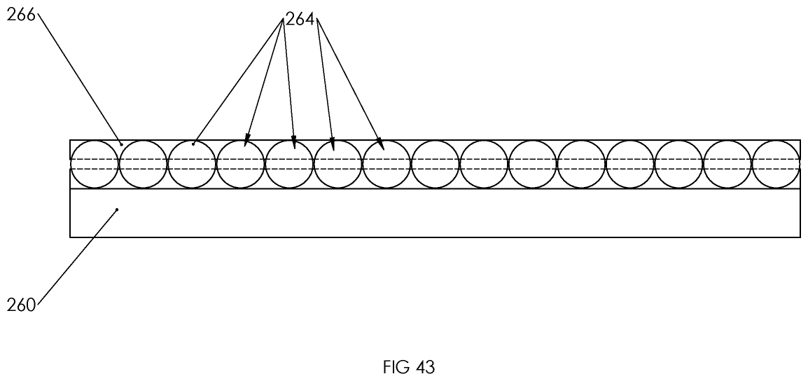

While the manipulation features (236) are advantageous for automated part manipulation, they must be removed prior to sintering, or they will necessitate a secondary machining process for removal, which would make the overall production process less efficient. FIG. 43 shows one method to facilitate easy removal of manipulation features (236). Powder (264) that exists at the boundary between the part (234) and the manipulation features (236) may be bound such that it is tangentially secured to material on the part (260) and also tangentially secured to material on the manipulation features (266). Thus, the manipulation features (236) are nominally connected to the part (234) to aid in automated handling, though there is no continuous region of cured polymer binder that connects them. This enables the manipulation features (236) to be sheared off prior to sintering without damaging the part (234).

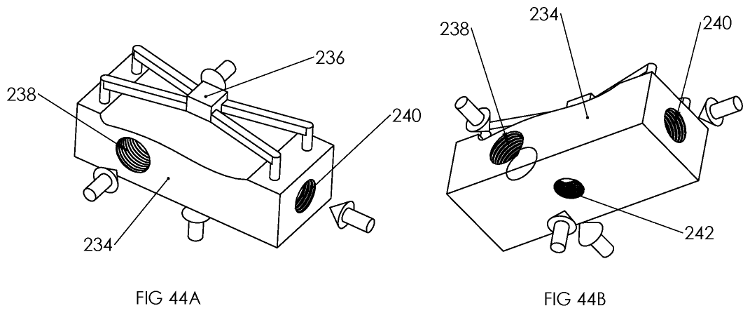

The parts (234) in question have multiple threaded holes (238,240,242) which would in general make the parts (234) difficult or impossible to mold and create additional spaces where material may be trapped and from which material must be removed before any additional post-processing. As in the previously discussed case where a metal or ceramic powder is bound together during the build process with the intent of being sintered to form a solid metal or ceramic part that is devoid of polymer, excess material must be removed before sintering, otherwise it would bond to the part (234) and would compromise the accuracy of the overall production process. FIGS. 44A and 44B show vectors which identify the entry points to enclosed areas. These may be utilized as wash vectors for a nozzle-based washing system for removing excess material. In general, the method of identifying wash vectors, which are the normal vectors of the centroids of entrances to confined volumes in a solid part, using those wash vectors to determine part orientation relative to a nozzle wash system, and exposing that part to the wash system in a sequence of orientations to ensure thorough removal of all excess material, may be used to process parts made using the previously described system.

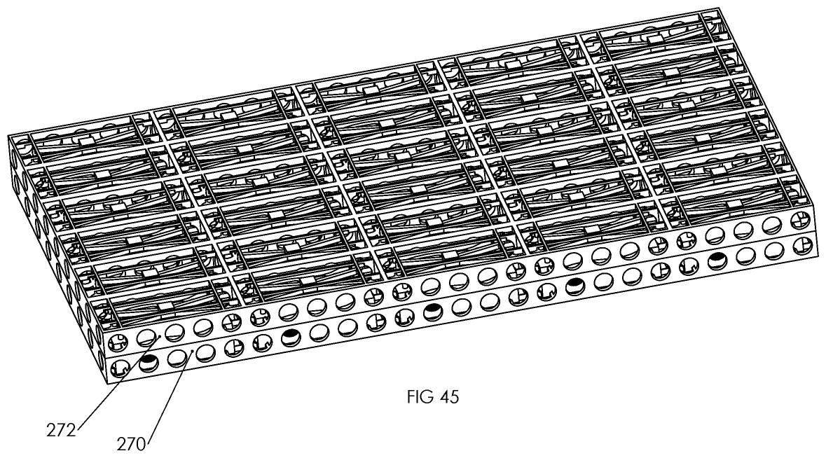

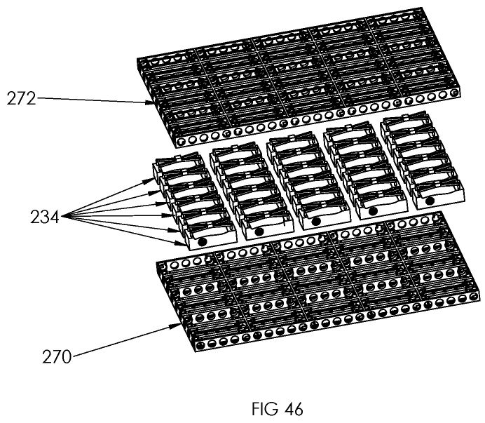

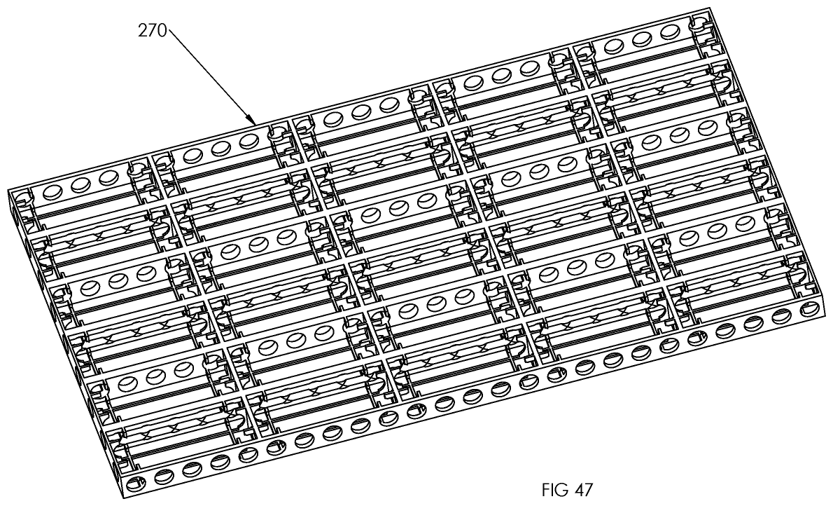

FIGS. 45-47 depict an alternate mans of post-processing printed parts. Support material (270,272) may be built along with the parts (234) such that the parts (234) are contained within the support material (270,272) but the support material allows for material flow out of the parts (234) during a secondary washing operation. In this instance, the parts (234) may be held inside the support material (270,272) while the entire assembly is exposed to a solvent wash process, possibly involving sonic or other mechanical agitation while changing the assembly orientation to allow material to flow out of any confined spaces. This converts the previous single unit wash process to a batch process, which may be more efficient for large scale manufacturing.

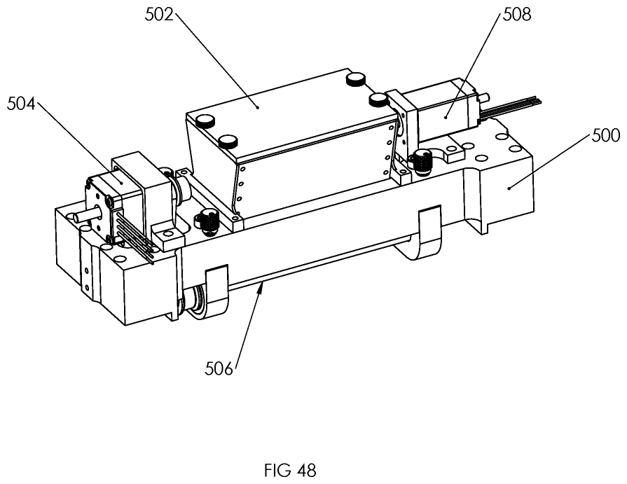

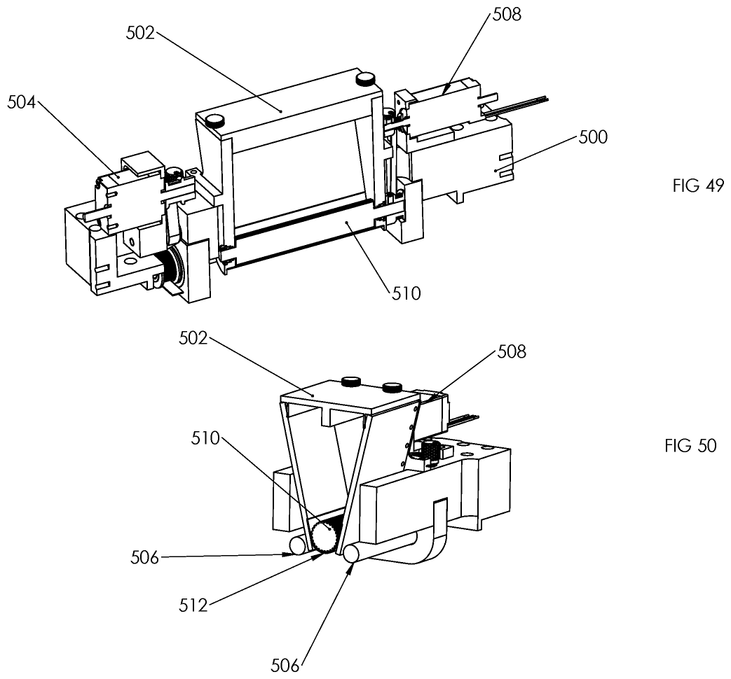

FIGS. 48-50 depict an alternate embodiment of a powder dispensing mechanism. The powder deposition module (500) is comprised of a hopper (502), a roller actuator (504), rollers (506), a powder shearing member (510), a powder shearing actuator (508), and a mesh screen (512). As previously discussed, while rollers (506) are employed here to condition the layer of deposited powder, a blade or other means may also be implemented. In this deposition method, powder is normally not permitted to pass through the mesh (512) which consists of a plurality of holes that are appropriately sized relative to the powder used in order to create the arching behavior previously described. In this instance, rather than using vibration to agitate the arched powder, a shear force is applied by a shearing member (510) driven by a shearing actuator (508) to disrupt the arch and allow powder to flow through the screen (512). In this particular embodiment, two rollers (506) are used such that powder may be deposited as the module (500) traverses the build area in either a forward or backward direction.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1. An apparatus for producing a high-resolution image comprising:
a display unit configured for projecting an image comprising one or more beams of radiation on a surface;
at least one refractive element comprising a transparent material positioned between the display unit and the surface, wherein the at least one refractive element is configured to transmit the one or more beams of radiation as one or more exigent beams of radiation, and wherein the at least one refractive element is rotatable to shift a position of the image relative to the surface.

2. The apparatus of claim 1, wherein the display unit comprises a digital micromirror device.

3. The apparatus of claim 1, wherein the display unit comprises a plurality of pixels that are spaced apart from one another by a distance that is greater than a width of the pixels.

4. The apparatus of claim 1, wherein the at least one refractive element comprises:
a first refractive pixel shifter that is pivotable about a first rotation axis; and
a second refractive pixel shifter that is pivotable about a second rotation axis that is different than the first rotation axis.

5. The apparatus of claim 4, wherein the second rotation axis is substantially perpendicular to the first rotation axis.

6. The apparatus of claim 1, wherein the at least one refractive element comprises a plurality of static refractive elements that are arranged at different angles relative to the surface.

7. The apparatus of claim 1, comprising collimation optics positioned between the display unit and the at least one refractive element, wherein the collimation optics are configured for collimating the beams of radiation.

8. The apparatus of one of claim 1 or claim 7, comprising projection optics configured to focus the exigent beams of radiation from the at least one refractive element to adjust a size of the image on the surface.

9. A method for producing a high-resolution image, the method comprising:
projecting an image from a display unit toward a surface, the image comprising one or more beam of radiation;
positioning at least one refractive element between the display unit and the surface;
transmitting the one or more beam of radiation through the at least one refractive element to produce one or more exigent beams of radiation directed toward the surface; and
varying a rotational position of the at least one refractive element to adjust a position of the image relative to the surface.

10. The method of claim 9, wherein the display unit comprises a digital micromirror device, and wherein projecting an image comprises positioning one or more pixels of the digital micromirror device in an “on” state.

11. The method of claim 9, wherein varying a rotational position of the at least one refractive element comprises rotating the at least one refractive element to shift a position of the image relative to the surface.

12. The method of claim 9, wherein positioning the at least one refractive element comprises:
positioning a first refractive pixel shifter between the display unit and the surface, wherein the first refractive pixel shifter is pivoted about a first rotation axis to a desired position; and
positioning a second refractive pixel shifter between the first refractive pixel shifter and the surface, wherein the second refractive pixel shifter is pivoted about a second rotation axis that is different than the first rotation axis to a desired position.

13. The method of claim 12, wherein the second rotation axis is substantially perpendicular to the first rotation axis.

14. The method of claim 9, wherein positioning the at least one refractive element comprises positioning a plurality of static refractive elements between the display unit and the surface; and
wherein varying a rotational position of the at least one refractive element comprises arranging the plurality of static refractive elements at different angles relative to the surface.

15. The method of claim 9, comprising collimating the one or more beams of radiation prior to transmitting the one or more beam of radiation through the at least one refractive element.

16. The method of claim 9, comprising focusing the exigent beams of radiation from the at least one refractive element to adjust a size of the image on the surface.

17-48. (canceled)

49. The apparatus of claim 3, wherein the at least one refractive element is configured to transmit the plurality of pixels towards the surface as an array of small pixels that are spaced apart by a distance that is larger than a width of the small pixels; and
wherein the at least one refractive element is rotatable to adjust a position of the array of small pixels to collectively produce the image on the surface.

50. The method of claim 9, wherein projecting an image from the display unit comprises projecting an image comprising an array of small pixels that are spaced apart by a distance that is larger than a width of the small pixels; and
wherein varying the rotational position of the at least one refractive element comprises adjusting a position of the array of small pixels to collectively produce the image on the surface.

51. The method of claim 9, wherein projecting an image from the display unit comprises:
determining a desired position of the image relative to the surface;
applying an inversion function to the desired position of the image to generate a modified image based on a predetermined pixel shift effect of the at least one refractive element; and
projecting the modified image from the display unit.
